(19) United States
(12) Patent Application Publication
(10) Pub. No.: US 2026/0285203 A1
(43) Pub. Date: Sep. 24, 2026

(54) Seat Swivel Assembly for Vehicle

(71) Applicant: Daechang Seat Co., LTD - Dongtan, Hwaseong-si (KR)

(72) Inventors: Chan Ki Cho, Pyeongchang-gun (KR); Gun Young Park, Yongin-si (KR); Kyoung Jae Lee, Hwaseong-si (KR); Jeon ll Kang, Cheonan-si (KR); Jae Kwang Shin, Hwaseong-si (KR)

(21) Appl. No.: 19/560,705

(22) Filed: Mar. 9, 2026

(30) Foreign Application Priority Data
Mar. 20, 2025 (KR) 10-2025-0035668

(51) Int. Cl. B60N 2/14

(52) U.S. Cl. CPC B60N 2/146

(57) ABSTRACT

Proposed is a seat swivel assembly for a vehicle, which can suppress rotational play by controlling the clearance between the components of the assembly. The assembly includes a support plate having a support plate center hole formed at a center thereof and having a first fastening hole and a second fastening hole formed side by side on a side surface thereof in a circumferential direction of the support plate center hole, an upper plate whose lower surface is in rolling contact with an upper surface of the support plate so as to rotate about an axis of the support plate center hole, and a locking unit installed on the upper plate such that an end thereof is insertable into the first fastening hole and the second fastening hole, and configured to restrict or allow rotation of the upper plate.

### CROSS REFERENCE TO RELATED APPLICATION

The present application claims priority to Korean Patent Application No. 10-2025-0035668, filed Mar 20, 2025, the entire contents of which is incorporated herein for all purposes by this reference.

### BACKGROUND

### Technical Field

The present disclosure relates to a seat swivel assembly for a vehicle and, more particularly, to a seat swivel assembly for a vehicle, which can control clearance to suppress play.

### Description of the Related Art

In general, a seat swivel assembly is installed between the seat mechanism, such as the seat cushion, and a vehicle’s floor, or between the seat mechanism and seat tracks (or rails/sliders), and allows a seat to rotate by approximately 180 degrees. The seat swivel assembly is typically installed in passenger vehicles equipped with three or more seat rows. Seat swivels are classified into two primary types: power-operated seat swivels and manual seat swivels, with the primary difference being the method of rotation. Power swivels use an electric motor for automatic rotation, while manual swivels rely on the user’s physical force. To enhance user convenience, power-operated seat swivels are widely used.

Korean Patent No. 10-1944078 discloses a swivel locking device.

The swivel locking device disclosed in the above Patent Document consists of: an upper circular plate coupled to a vehicle seat; a middle circular plate coupled to vehicle rails and rotatably engaged with the lower surface of the upper circular plate about an axis formed vertically by means of ball bearings mounted on the upper side of the middle circular plate; a lower circular plate provided below the middle circular plate and coupled to the upper circular plate; a locking portion that is coupled at one end to the upper circular plate and elastically presses the middle circular plate and the ball bearings at the other end; and a lever portion coupled to the upper circular plate and configured to release the pressing force of the locking portion in response to actuation of a lever.

The above-described swivel locking device provides a predetermined clearance between the upper circular plate and the lower circular plate to allow rotation of the upper circular plate relative to the lower circular plate. That is, in the locked state provided by the locking portion, if a seated occupant’s movement causes a shift in load, the rotational clearance between the upper circular plate and the lower circular plate may result in vibration and corresponding noise.

### Document of Related Art

(Patent Document 1) Korean Patent No. 10-1944078 (Registered January 24, 2019)

### SUMMARY

Accordingly, the present disclosure has been made keeping in mind the above problems occurring in the related art, and the present disclosure is intended to provide a seat swivel assembly for a vehicle, which can suppress rotational play by controlling the clearance between the components of the assembly.

In order to achieve the above objective, according to an aspect of the present disclosure, there is provided a seat swivel assembly for a vehicle, the assembly including: a support plate having a support plate center hole formed at a center thereof and having a first fastening hole and a second fastening hole formed side by side on a side surface thereof in a circumferential direction of the support plate center hole; an upper plate whose lower surface is in rolling contact with an upper surface of the support plate so as to rotate about an axis of the support plate center hole; and a locking unit installed on the upper plate such that an end thereof is insertable into the first fastening hole and the second fastening hole, and configured to restrict or allow rotation of the upper plate.

In addition, the locking unit of the seat swivel assembly according to an embodiment may include: a mounting bracket provided at an edge of the upper plate; a first hook lever hinge-coupled to the mounting bracket such that an end thereof is insertable into the first fastening hole; and a second hook lever hinge-coupled to the mounting bracket such that an end thereof is insertable into the second fastening hole.

In addition, the first hook lever of the seat swivel assembly according to an embodiment may be inserted into the first fastening hole before the second hook lever is inserted into the second fastening hole.

In addition, the second hook lever of the seat swivel assembly according to an embodiment may have a second side tapered toward a first side thereof facing the first hook lever.

In addition, the first hook lever and the second hook lever of the seat swivel assembly according to an embodiment may be coaxially hinge-coupled to the mounting bracket.

Unlike conventional technology, where a swivel seat is fixed by a single hook, the seat swivel assembly for a vehicle according to an embodiment employs two hooks, one for maintaining rigidity and the other for controlling clearance. To be specific, the first hook lever is configured to maintain rigidity while the second hook lever is configured to control clearance. As a result, unlike the conventional technology in which the hook may disengage due to rotational forces, the first and second hook levers do not disengage, thereby enhancing operational reliability.

Furthermore, since the seat swivel assembly for a vehicle according to an embodiment suppresses unwanted movement, vibration is reduced, and thus noise is decreased.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view of a seat swivel assembly for a vehicle according to an embodiment;

FIG. 2 is an exploded view of a seat swivel assembly for a vehicle according to an embodiment;

FIG. 3 is a perspective view of a locking unit according to an embodiment;

FIG. 4 is an exploded view of a locking unit according to an embodiment;

FIGS. 5 to 7 schematically show a state in which a seat swivel assembly for a vehicle according to an embodiment is fixed; and

FIGS. 8 and 9 schematically show a state in which a seat swivel assembly for a vehicle according to an embodiment is released.

### DETAILED DESCRIPTION

The advantages and features of the present disclosure, as well as the methods for achieving them, will become apparent from the following detailed description of embodiments taken in conjunction with the accompanying drawings. However, the present disclosure is not limited to the embodiments set forth herein and may be implemented in a variety of alternative forms. The embodiments described herein are provided to fully disclose the present disclosure and to enable those skilled in the art to understand the full scope of the present disclosure, and the present disclosure is defined solely by the scope of the claims. Throughout the specification, like reference numerals refer to like components.

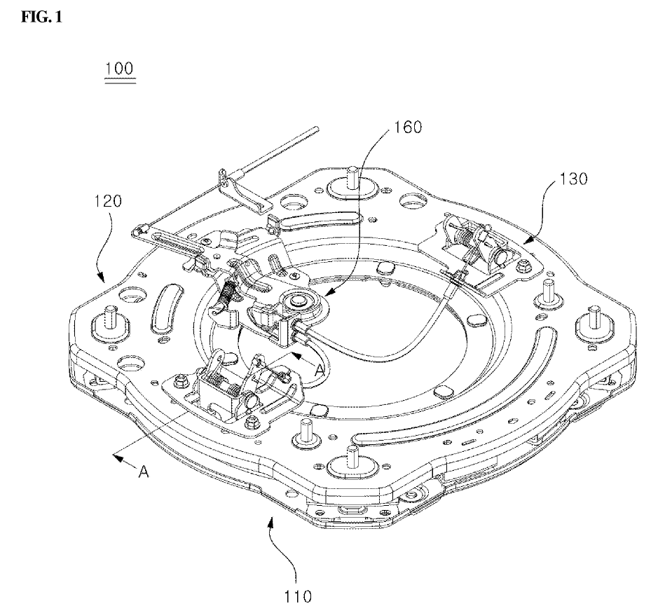

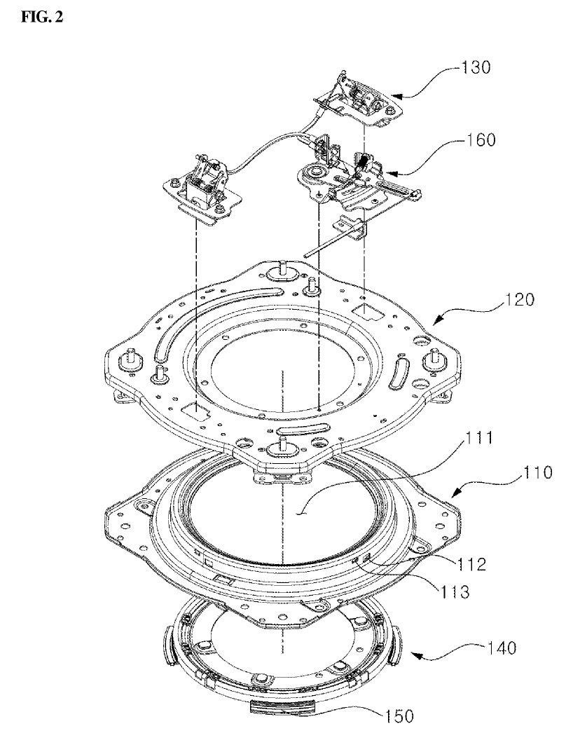

Referring to FIG. 1, which is a perspective view of a seat swivel assembly 100 for a vehicle [hereinafter referred to as the “vehicle seat swivel assembly 100”], and FIG. 2, which is an exploded view of the seat swivel assembly 100 for a vehicle according to an embodiment, the vehicle seat swivel assembly 100 includes a support plate 110, an upper plate 120, a locking unit 130, a lower plate 140, a rolling guide 150, and a release lever 160.

The support plate 110 has a support plate center hole 111 formed at a center thereof and may be fixed to a vehicle (not shown). In addition, the support plate 110 has a first fastening hole 112 and a second fastening hole 113 formed side by side on a side surface thereof in a circumferential direction of the support plate center hole 111.

The upper plate 120 is in rolling contact with an upper surface of the support plate 110 so as to be rotatable about an axis of the support plate center hole 111. In addition, an upper plate center hole may be formed at a center of the upper plate 120, and the upper plate 120 may be in rolling contact with the support plate 110 by means of a ball retainer B. At this time, a clearance may be adjusted by adjusting the angle of the ball retainer B that is in contact with portions of the support plate 110 and the upper plate 120. As the angle of the ball retainer B increases, an advantage is provided in terms of vertical clearance, whereas as the angle decreases, an advantage is provided in terms of horizontal clearance. In the present specification, the ball retainer B is illustrated as having an angle of 65 degrees.

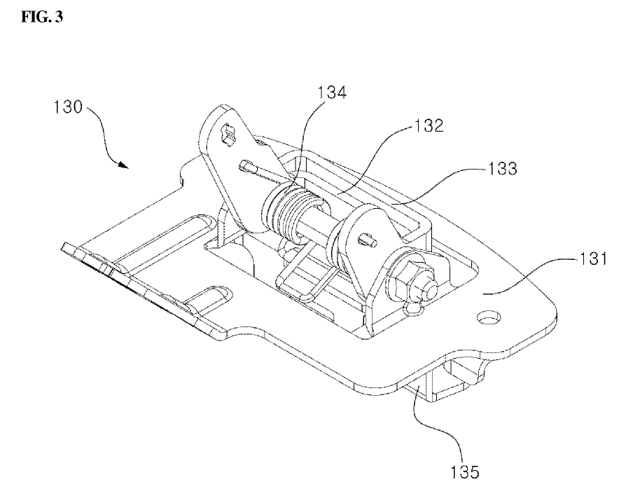

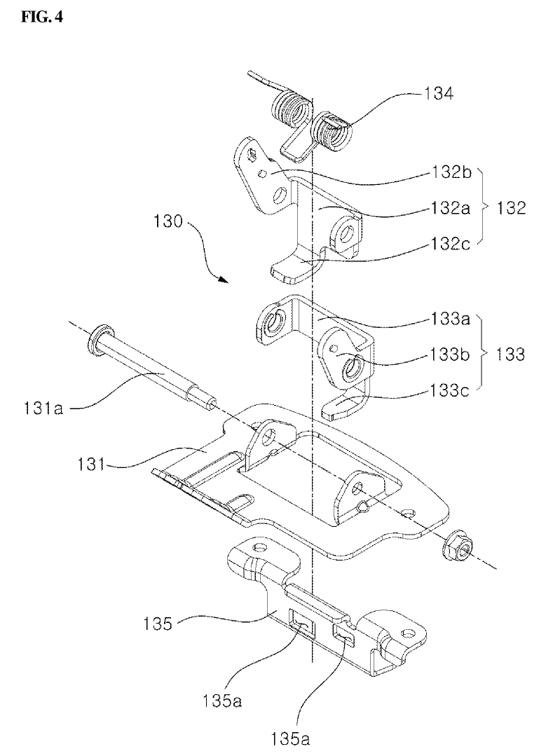

Referring to FIG. 3, which is a perspective view of the locking unit 130, and FIG. 4, which is an exploded view of the locking unit, the locking unit 130 is installed on the upper plate 120 such that an end thereof is insertable into the first fastening hole 112 and the second fastening hole 113, thereby restricting or allowing rotation of the upper plate 120. As an example, the locking unit 130 may include a mounting bracket 131, a first hook lever 132, a second hook lever 133, and a torsion spring 134.

The mounting bracket 131 is provided at an edge of an upper surface of the upper plate 120 so as to fix the locking unit 130 to the upper plate 120.

The first hook lever 132 is hinge-coupled to the mounting bracket 131 by a hinge shaft 131a such that an end thereof is insertable into the first fastening hole 112. As an example, the first hook lever 132 may include a body portion 132a, a lever portion 132b, and a hook portion 132c.

The body portion 132a has the hook portion 132c formed at one end thereof and is hinge-coupled to the mounting bracket 131 by the hinge shaft 131a such that the hook portion 132c is insertable toward the first fastening hole 112.

The lever portion 132b extends from the other end of the body portion 132a and is coupled to a cable of the release lever 160 to be described later to rotate the body portion 132a.

The hook portion 132c may have a curved hook shape extending from one end of the body portion 132a toward the first fastening hole 112.

The second hook lever 133 is hinge-coupled to the mounting bracket 131 by the hinge shaft 131a such that an end thereof is insertable into the second fastening hole 113. In addition, the second hook lever 133 may have the other side thereof tapered toward one side facing the first hook lever 132. As an example, the second hook lever 133 may include a body portion 133a, a lever portion 133b, and a hook portion 133c.

The body portion 133a has the hook portion 133c formed at one end thereof, and is hinge-coupled to the mounting bracket 131 by the hinge shaft 131a such that the hook portion 133c is insertable toward the second fastening hole 113. In addition, the body portion 133a is configured to be in surface contact with the body portion 132a of the first hook lever 132 so that when the body portion 132a of the first hook lever 132 rotates, the body portion 133a may rotate together with the body portion 132a.

The lever portion 133b extends from the other end of the body portion 133a.

The hook portion 133c may have a curved hook shape extending from one end of the body portion 133a toward the second fastening hole 113. The hook portion 133c may be formed such that the other side thereof is tapered toward one side facing the hook portion 132c of the first hook lever 132.

In addition, the second hook lever 133 may be hinge-coupled to the mounting bracket 131 so as to rotate while sharing the same axis, the hinge shaft 131a, as the first hook lever 132, and may be configured to be inserted into the second fastening hole 113 after the first hook lever 132 is inserted into the first fastening hole 112. This means that the first hook lever 132 enters before the second hook lever 133, rather than the second hook lever 133 being inserted after the first hook lever 132 is fully inserted.

The torsion spring 134 is provided on the hinge shaft 131a, with opposite ends thereof coupled to the lever portion 132b of the first hook lever 132 and the lever portion 133b of the second hook lever 133, respectively. The torsion spring 134 elastically supports the first hook lever 132 and the second hook lever 133, which are rotated by means of the release lever 160, so that the first hook lever 132 and the second hook lever 133 are returned and inserted into the first fastening hole 112 and the second fastening hole 113, respectively.

In addition, the locking unit 130 may further include a guide bracket 135.

The guide bracket 135 is provided on a lower surface of the upper plate 120 and functions to secure the locking unit 130 to the upper plate 120 together with the mounting bracket 131. In addition, the guide bracket 135 may be formed with a through hole 135a that guides the hook portion 132c of the first hook lever 132 and the hook portion 133c of the second hook lever 133.

The lower plate 140 has an upper surface in rolling contact with a lower surface of the support plate 110 so as to be rotatable about the axis of the support plate center hole 111. In addition, the lower plate 140 has the inner side thereof coupled to the inner side of the upper plate 120 so as to rotate together with the upper plate 120.

In addition, the lower plate 140 may be in rolling contact with the lower surface of the support plate 110 by means of a ball retainer B. At this time, a clearance may be adjusted by adjusting the angle of the ball retainer B at which the support plate 110 and the lower plate 140 are in contact. As the angle of the ball retainer B increases, an advantage is provided in terms of vertical clearance, whereas as the angle decreases, an advantage is provided in terms of horizontal clearance. In the present specification, the ball retainer B is illustrated as having an angle of 65 degrees.

The rolling guide 150 is disposed between the support plate 110 and the lower plate 140 and guides the lower plate 140 to rotate concentrically relative to the axis of the support plate center hole 111.

The release lever 160 is provided on the upper plate 120 and is connected to the lever portion 132b of the first hook lever 132 via a cable. A user may operate the release lever 160 to rotate the first hook lever 132 and the second hook lever 133.

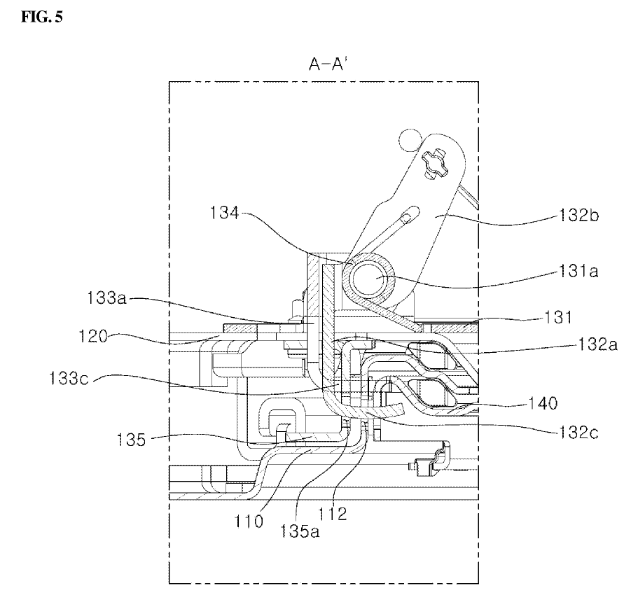

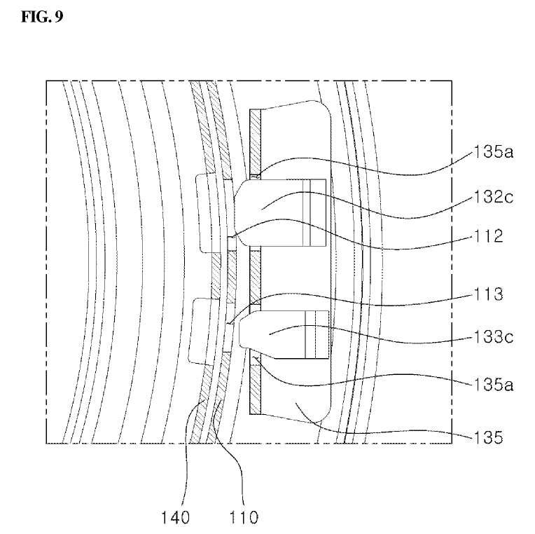

Referring to FIGS. 5 to 9, which schematically show the locked and released states of the vehicle seat swivel assembly 100, the operation of the locking unit 130 of the vehicle seat swivel assembly 100 will be described.

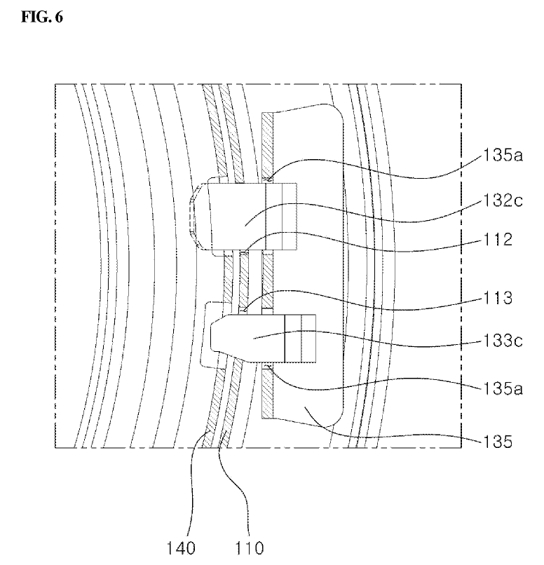

Referring to FIG. 5, which schematically illustrates a side view of the vehicle seat swivel assembly 100 in the locked state, and FIG. 6, which schematically illustrates a top view thereof, in the vehicle seat swivel assembly 100, the first hook lever 132 and the second hook lever 133 of the locking unit 130 are respectively inserted into the first fastening hole 112 and the second fastening hole 113. To be specific, one side of the first hook lever 132, which faces away from the second hook lever 133, is in contact with the first fastening hole 112, and the other side of the second hook lever 133, which faces away from the first hook lever 132, is in contact with the second fastening hole 113, thereby securing the upper plate 120 to the support plate 110. That is, rotation of the upper plate 120 is restricted.

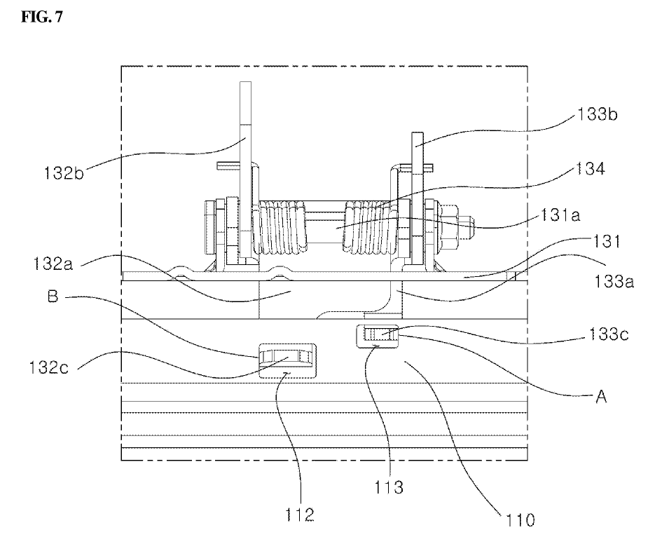

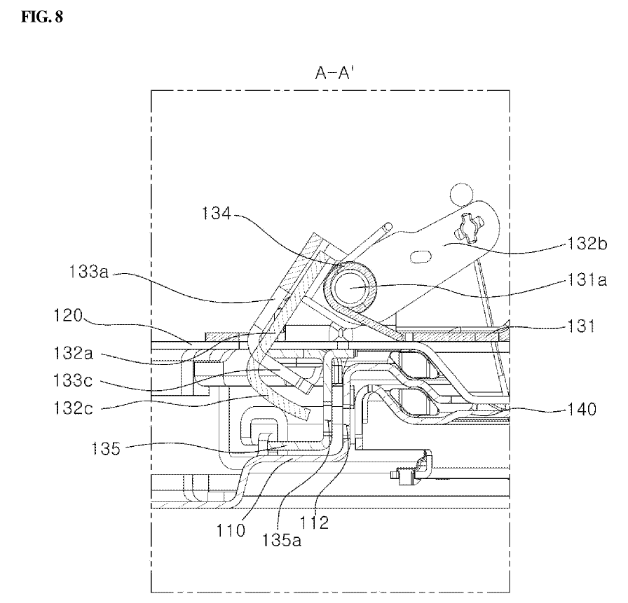

Referring to FIG. 7, which schematically illustrates a side view of the vehicle seat swivel assembly 100 in the released state, and FIG. 8, which schematically illustrates a top view thereof, the user operates the release lever 160 to rotate the first hook lever 132. At this time, the second hook lever 133, which is in surface contact with the first hook lever 132, also rotates together therewith, so that the first hook lever 132 and the second hook lever 133 disengage from the first fastening hole 112 and the second fastening hole 113, respectively.

Referring again to FIG. 6 and to FIG. 7, which schematically illustrates a front view of the vehicle seat swivel assembly 100 in the locked state, as the user releases the release lever 160, the first hook lever 132 and the second hook lever 133 are rotated by the torsion spring 134 toward the first fastening hole 112 and the second fastening hole 113, respectively. In this case, the first hook lever 132 is inserted into the first fastening hole 112 before the second hook lever 133 is inserted into the second fastening hole 113.

Since the other side of the second hook lever 133 is tapered toward one side facing the first hook lever 132, during insertion into the second fastening hole 113, the other side of the hook portion 133c of the second hook lever 133 contacts the second fastening hole 113 at point A, causing the upper plate 120 to rotate in the direction of the first hook lever 132. At this time, since the other side of the hook portion 132c of the first hook lever 132, which faces away from the second hook lever 133, is fixed while being inserted in the first fastening hole 112 at point B, the first hook lever 132 moves relative to the second hook lever 133 in the direction of the hinge shaft 131a. As a result, the clearance between the first hook lever 132 and the second hook lever 133, as well as the clearance between the first hook lever 132 and the mounting bracket 131, is controlled.

In addition, the upper plate 120 is supported at the point A by the first hook lever 132 and at the point B by the second hook lever 133, so that movement of the upper plate 120 in both clockwise and counterclockwise directions is simultaneously restrained, thereby fixing the upper plate 120 to the support plate 110 without clearance.

The expressions (terms, visualized images, etc.) used to describe the embodiments of the present disclosure are merely selected for the purpose of facilitating understanding of the technology.

Furthermore, due to practical constraints, the present disclosure has been described with a limited number of embodiments, and those of ordinary skill in the art would be able to conceive new embodiments based on the described embodiments without departing from the technical spirit of the present disclosure.

Therefore, the claims of the present disclosure should not be construed as being limited by the specific expressions appearing in the “Description of the Invention” or the “Drawings”, but should be broadly interpreted based on the inherent technical concept of the disclosure as a whole.

What is claimed is:

1. A seat swivel assembly for a vehicle, the assembly comprising:
a support plate having a support plate center hole formed at a center thereof and having a first fastening hole and a second fastening hole formed side by side on a side surface thereof in a circumferential direction of the support plate center hole;
an upper plate whose lower surface is in rolling contact with an upper surface of the support plate so as to rotate about an axis of the support plate center hole; and
a locking unit installed on the upper plate such that an end thereof is insertable into the first fastening hole and the second fastening hole, and configured to restrict or allow rotation of the upper plate.

2. The assembly of claim 1, wherein the locking unit comprises:
a mounting bracket provided at an edge of the upper plate;
a first hook lever hinge-coupled to the mounting bracket such that an end thereof is insertable into the first fastening hole; and
a second hook lever hinge-coupled to the mounting bracket such that an end thereof is insertable into the second fastening hole.

3. The assembly of claim 2, wherein the first hook lever is inserted into the first fastening hole before the second hook lever is inserted into the second fastening hole.

4. The assembly of claim 3, wherein the second hook lever has a second side tapered toward a first side thereof facing the first hook lever.

5. The assembly of claim 2, wherein the first hook lever and the second hook lever are coaxially hinge-coupled to the mounting bracket.
